(19) United States
(12) Patent Application Publication
(10) Pub. No.: US 2024/0119592 A1
(43) Pub. Date: Apr. 11, 2024

(54) INFORMATION PROCESSING APPARATUS, INFORMATION PROCESSING METHOD, AND PROGRAM

(71) Applicant: FUJIFILM Corporation, Tokyo (JP)

(72) Inventors: Taro HATSUTANI, Tokyo (JP); Akimichi ICHINOSE, Tokyo (JP)

(73) Assignee: FUJIFILM Corporation, Tokyo (JP)

(21) Appl. No.: 18/476,320

(22) Filed: Sep. 28, 2023

(30) Foreign Application Priority Data
Oct. 7, 2022 (JP) 2022-162253

(51) Int. Cl. G06T 7/00; G06V 10/25

(52) U.S. Cl. CPC G06T 7/0012; G06V 10/25; G06T 2207/30096; G06V 2201/07

(57) ABSTRACT

An information processing apparatus, an information processing method, and a program that can determine a region-of-interest candidate of an image using information related to the image are provided.

An information processing apparatus includes one or more processors, and one or more storage devices in which an instruction executed by the one or more processors is stored, in which the one or more processors are configured to acquire an image, related information related to the image, and one or more first region-of-interest candidates included in the image, estimate one or more image regions indicated by the related information from the image and from the related information, and determine a second region-of-interest candidate from among the first region-of-interest candidates based on the estimated image region.

### CROSS-REFERENCE TO RELATED APPLICATION

The present application claims priority under 35 U.S.C § 119(a) to Japanese Patent Application No. 2022-162253 filed on Oct. 7, 2022, which is hereby expressly incorporated by reference, in its entirety, into the present application.

### BACKGROUND OF THE INVENTION

### 1. Field of the Invention

The present invention relates to an information processing apparatus, an information processing method, and a program, and particularly to a technology for determining a region-of-interest candidate of an image.

### 2. Description of the Related Art

Training an object detection model requires a large amount of correct answer data (for example, bounding boxes). However, manual annotation incurs a cost. Therefore, there has been a study for improving performance of the object detection model using information other than the correct answer data. A technique for additionally learning data annotated at an image level (for example, data used in class classification) is disclosed in Hoffman, Judy, et al. “Detector discovery in the wild: Joint multiple instance and representation learning.” Proceedings of the IEEE conference on computer vision and pattern recognition, 2015.

In addition, JP7080304B discloses a method of training a model that predicts text information from an image using an image of a region of interest and a text of a position, a size, a property, or the like associated with the image of the region of interest as training data.

### SUMMARY OF THE INVENTION

Medical data is generally present as a pair of an image and a report related to the image. However, improving the object detection model using the image and the report has not been performed.

In addition, while the method disclosed in JP7080304B is based on the premise that the region of interest and the text are associated with each other, which information is associated with which region of interest may not be known in a case where the region of interest included in the image and information related to the image are not associated with each other.

The present invention is conceived in view of such circumstances, and an object thereof is to provide an information processing apparatus, an information processing method, and a program that can determine a region-of-interest candidate of an image using information related to the image.

In order to achieve the object, an information processing apparatus according to a first aspect of the present disclosure is an information processing apparatus comprising one or more processors, and one or more storage devices in which an instruction executed by the one or more processors is stored, in which the one or more processors are configured to acquire an image, related information related to the image, and one or more first region-of-interest candidates included in the image, estimate one or more image regions indicated by the related information from the image and from the related information, and determine a second region-of-interest candidate from among the first region-of-interest candidates based on the estimated image region.

According to the present aspect, a region-of-interest candidate (second region-of-interest candidate) in the image corresponding to the related information can be determined using the related information related to the image, and the related information and a region of interest in the image can be associated with each other. In addition, performance of an object detection model can be improved using information about the region-of-interest candidate in the image determined in the present aspect.

An information processing apparatus according to a second aspect of the present disclosure is the information processing apparatus according to the first aspect, in which the related information may include a text related to a content of the image.

An information processing apparatus according to a third aspect of the present disclosure is the information processing apparatus according to the first aspect, in which the related information may include a text described with respect to a region of interest included in the image.

An information processing apparatus according to a fourth aspect of the present disclosure is the information processing apparatus according to the first aspect, in which the related information may include information about a structured text including at least one of a size, a position, or a property of a region of interest included in the image.

An information processing apparatus according to a fifth aspect of the present disclosure is the information processing apparatus according to any one of the second to fourth aspects, in which the one or more processors may be configured to estimate at least one of a position, a size, or a property indicated by the text.

An information processing apparatus according to a sixth aspect of the present disclosure is the information processing apparatus according to any one of the second to fifth aspects, in which the image may be a medical image, and the one or more processors may be configured to recognize an organ included in the image, and estimate the image region from the text and from a recognition result of the organ.

An information processing apparatus according to a seventh aspect of the present disclosure is the information processing apparatus according to any one of the first to sixth aspects, in which the one or more first region-of-interest candidates may include at least one of a bounding box, a heatmap, or a mask.

An information processing apparatus according to an eighth aspect of the present disclosure is the information processing apparatus according to any one of the first to seventh aspects, in which the one or more processors may be configured to receive input of the image, the related information, and the one or more first region-of-interest candidates.

An information processing apparatus according to a ninth aspect of the present disclosure is the information processing apparatus according to any one of the first to seventh aspects, in which the one or more processors may be configured to receive input of the image and the related information, and acquire the one or more first region-of-interest candidates by generating the one or more first region-of-interest candidates based on the received image.

An information processing apparatus according to a tenth aspect of the present disclosure is the information processing apparatus according to the ninth aspect, in which the one or more processors may be configured to perform processing of disposing a plurality of bounding boxes as the first region-of-interest candidates at a constant interval on the image in a rule-based manner.

An information processing apparatus according to an eleventh aspect of the present disclosure is the information processing apparatus according to the ninth aspect, in which the one or more processors may be configured to generate the one or more first region-of-interest candidates from the image using a machine learning model that is trained to receive input of the image and estimate the one or more first region-of-interest candidates from the image.

An information processing apparatus according to a twelfth aspect of the present disclosure is the information processing apparatus according to the ninth aspect, in which the one or more processors may be configured to generate the one or more first region-of-interest candidates from the image using an object detection model.

An information processing apparatus according to a thirteenth aspect of the present disclosure is the information processing apparatus according to the twelfth aspect, in which the object detection model may be a model that is trained by machine learning using training data including the determined second region-of-interest candidate.

An information processing apparatus according to a fourteenth aspect of the present disclosure is the information processing apparatus according to any one of the first to thirteenth aspects, in which the one or more processors may be configured to determine the first region-of-interest candidate included in the estimated image region among the one or more first region-of-interest candidates as the second region-of-interest candidate.

An information processing apparatus according to a fifteenth aspect of the present disclosure is the information processing apparatus according to any one of the first to fourteenth aspects, in which the one or more processors may be configured to acquire a plurality of the first region-of-interest candidates, and determine the second region-of-interest candidate from among the plurality of first region-of-interest candidates.

An information processing apparatus according to a sixteenth aspect of the present disclosure is the information processing apparatus according to any one of the first to fifteenth aspects, in which the one or more processors may be configured to calculate a probability for the image region indicated by the related information in pixel units of the image.

An information processing apparatus according to a seventeenth aspect of the pre sent disclosure is the information processing apparatus according to any one of the first to sixteenth aspects, in which the image region estimated by the one or more processors may include at least one of a bounding box, a heatmap, or a mask.

An information processing apparatus according to an eighteenth aspect of the present disclosure is the information processing apparatus according to any one of the first to seventeenth aspects, in which the one or more processors may be configured to calculate a confidence degree of the first region-of-interest candidate, and delete the first region-of-interest candidate not corresponding to the estimated image region among the one or more first region-of-interest candidates.

An information processing apparatus according to a nineteenth aspect of the present disclosure is the information processing apparatus according to any one of the first to eighteenth aspects, in which the one or more processors may be configured to calculate an evaluation value of the one or more first region-of-interest candidates from the estimated image region, and determine the second region-of-interest candidate based on the evaluation value.

In order to achieve the object, an information processing method according to a twentieth aspect of the present disclosure is an information processing method executed by one or more processors, the information processing method comprising, via the one or more processors, acquiring an image, related information related to the image, and one or more first region-of-interest candidates included in the image, estimating one or more image regions indicated by the related information from the image and from the related information, and determining a second region-of-interest candidate from among the first region-of-interest candidates based on the estimated image region. According to the present aspect, since the region-of-interest candidate of the image can be determined using the related information related to the image, the performance of the object detection model can be improved using the image in which the region-of-interest candidate is determined.

The information processing method according to the twentieth aspect can be configured to include the same specific aspect of the information processing apparatus according to any one of the second to nineteenth aspects.

In order to achieve the object, a program according to a twenty-first aspect of the present disclosure is a program causing a computer to implement a function of acquiring an image, related information related to the image, and one or more first region-of-interest candidates included in the image, a function of estimating one or more image regions indicated by the related information from the image and from the related information, and a function of determining a second region-of-interest candidate from among the first region-of-interest candidates based on the estimated image region. According to the present aspect, since the region-of-interest candidate of the image can be determined using the related information related to the image, the performance of the object detection model can be improved using the image in which the region-of-interest candidate is determined.

The program according to the twenty-first aspect can be configured to include the same specific aspect of the information processing apparatus according to any one of the second to nineteenth aspects.

The present disclosure also includes a computer readable non-transitory recording medium such as a compact disk-read only memory (CD-ROM) in which the program according to the twenty-first aspect is stored.

According to the present invention, the region-of-interest candidate of the image can be determined using the related information related to the image. In addition, the performance of the object detection model can be improved using the information about the region-of-interest candidate determined in the present invention.

### BRIEF DESCRIPTION OF THE DRAWINGS

FIG. 1 is an overall configuration diagram of a medical information processing system.

FIG. 2 is a block diagram illustrating an electric configuration of a medical information processing apparatus.

FIG. 3 is a block diagram illustrating a functional configuration of the medical information processing apparatus.

FIG. 4 is a flowchart illustrating a medical information processing method according to a first embodiment.

FIG. 5 is a diagram for describing processing of each step of the medical information processing method.

FIG. 6 is a diagram for describing the processing of each step of the medical information processing method.

FIG. 7 is a diagram for describing the processing of each step of the medical information processing method.

FIG. 8 is a diagram for describing an example of processing performed by an image region estimation unit.

FIG. 9 is a diagram for describing another example of the processing performed by the image region estimation unit.

FIG. 10 is a block diagram schematically illustrating a functional configuration of an object detection system according to a second embodiment.

### DESCRIPTION OF THE PREFERRED EMBODIMENTS

Hereinafter, preferred embodiments of the present invention will be described in detail with reference to the accompanying drawings. Here, a medical information processing apparatus, a medical information processing method, and a medical information processing program will be illustratively described as examples of an information processing apparatus, an information processing method, and a program according to an embodiment of the present invention.

Medical Information Processing System

A medical information processing system according to the present embodiment is a system that determines, from a medical image having related information, a region-of-interest candidate which is a lesion candidate of the medical image. Performance of a learning model that estimates the region of interest from the medical image can be improved by using the medical image of which the region-of-interest candidate is determined as correct answer data for training the learning model.

FIG. 1 is an overall configuration diagram of a medical information processing system 10. As illustrated in FIG. 1, the medical information processing system 10 is configured to comprise a medical image examination apparatus 12, a medical image database 14, a user terminal apparatus 16, a reading report database 18, and a medical information processing apparatus 20.

The medical image examination apparatus 12, the medical image database 14, the user terminal apparatus 16, the reading report database 18, and the medical information processing apparatus 20 are connected to each other through a network 22 to be capable of transmitting and receiving data. The network 22 includes a wired or wireless local area network (LAN) that connects various apparatuses to communicate with each other in a medical institution. The network 22 may include a wide area network (WAN) that connects a plurality of medical institutions to each other.

The medical image examination apparatus 12 is an imaging apparatus that images an examination target part of a subject to generate a medical image. Examples of the medical image examination apparatus 12 include an X-ray imaging apparatus, a computed tomography (CT) apparatus, a magnetic resonance imaging (MRI) apparatus, a positron emission tomography (PET) apparatus, an ultrasound apparatus, a computed radiography (CR) apparatus using a planar X-ray detector, and an endoscope apparatus.

The medical image database 14 is a database that manages the medical image captured by the medical image examination apparatus 12. A computer comprising a high-capacity storage device for storing the medical image is applied as the medical image database 14. The computer incorporates software that provides a function of a database management system.

The medical image may be a two-dimensional still image or a three-dimensional still image captured by an X-ray imaging apparatus, a CT apparatus, an MRI apparatus, or the like or may be a video captured by an endoscope apparatus.

A digital imaging and communications in medicine (Dicom) standard can be applied as a format of the medical image. Accessory information (Dicom tag information) defined in the Dicom standard may be added to the medical image. The term “image” in the present specification includes not only a meaning of the image itself such as a photo but also a meaning of image data that is a signal representing the image.

The user terminal apparatus 16 is a terminal apparatus with which a doctor creates and views a reading report. For example, a personal computer is applied as the user terminal apparatus 16. The user terminal apparatus 16 may be a workstation or may be a tablet terminal. The user terminal apparatus 16 comprises an input device 16A and a display 16B. The doctor inputs an instruction to display the medical image using the input device 16A. The user terminal apparatus 16 displays the medical image on the display 16B. Furthermore, the doctor reads the medical image displayed on the display 16B and creates the reading report that is a reading result using the input device 16A.

The reading report is the related information paired with the medical image. The related information includes a text related to a content of the medical image. The related information may include a text described with respect to the region of interest included in the medical image. The related information may include information about a structured text including at least one of a size, a position, or a property of the region of interest included in the medical image. The related information may not be associated with the region of interest of the medical image.

The reading report database 18 is a database that manages the reading report generated by the doctor in the user terminal apparatus 16. A computer comprising a high-capacity storage device for storing the reading report is applied as the reading report database 18. The computer incorporates software that provides the function of the database management system. The medical image database 14 and the reading report database 18 may be composed of one computer.

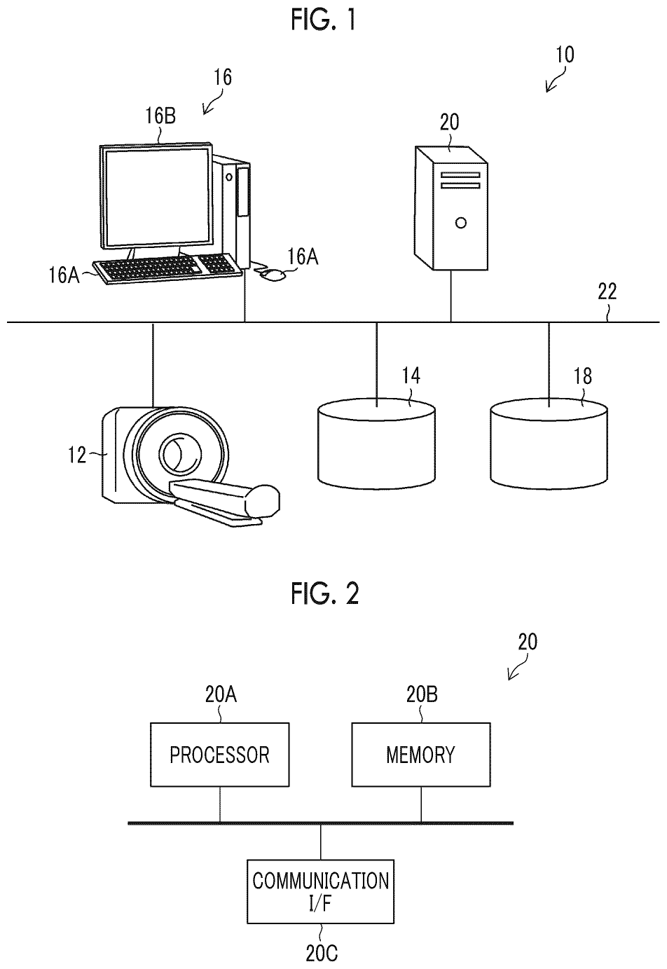

The medical information processing apparatus 20 is an apparatus that determines the region-of-interest candidate of the medical image. A personal computer or a workstation (an example of a “computer”) can be applied as the medical information processing apparatus 20. FIG. 2 is a block diagram illustrating an electric configuration of the medical information processing apparatus 20. As illustrated in FIG. 2, the medical information processing apparatus 20 comprises a processor 20A, a memory 20B, and a communication interface 20C.

The processor 20A executes an instruction stored in the memory 20B. A hardware structure of the processor 20A includes the following various processors. The various processors include a central processing unit (CPU) that is a general-purpose processor acting as various functional units by executing software (program), a graphics processing unit (GPU) that is a processor specialized in image processing, a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute specific processing, and the like.

One processing unit may be composed of one of the various processors or may be composed of two or more processors of the same type or different types (for example, a plurality of FPGAs, a combination of a CPU and an FPGA, or a combination of a CPU and a GPU). In addition, a plurality of functional units may be composed of one processor. A first example of the plurality of functional units composed of one processor is, as represented by a computer such as a client or a server, a form of one processor composed of a combination of one or more CPUs and software, in which the processor acts as the plurality of functional units. A second example is, as represented by a system on chip (SoC) or the like, a form of using a processor that implements functions of the entire system including the plurality of functional units in one integrated circuit (IC) chip. In such a manner, various functional units are configured using one or more of the various processors as a hardware structure.

Furthermore, the hardware structure of the various processors is, more specifically, an electric circuit (circuitry) in which circuit elements such as semiconductor elements are combined.

The memory 20B is a storage device in which the instruction executed by the processor 20A is stored. The memory 20B may be composed of two or more storage devices. The memory 20B includes a random access memory (RAM) and a read only memory (ROM), not illustrated. The processor 20A executes software in the RAM as a work region using various programs including the medical information processing program, described later, and a parameter stored in the ROM and executes various types of processing of the medical information processing apparatus 20 using the parameter stored in the ROM or the like.

The communication interface 20C controls communication with the medical image examination apparatus 12, the medical image database 14, the user terminal apparatus 16, and the reading report database 18 through the network 22 in accordance with a predetermined protocol.

The medical information processing apparatus 20 may be a cloud server that can be accessed from a plurality of medical institutions through the Internet. Processing performed in the medical information processing apparatus 20 may be a paid or fixed-rate cloud service.

Functional Configuration of Medical Information Processing Apparatus

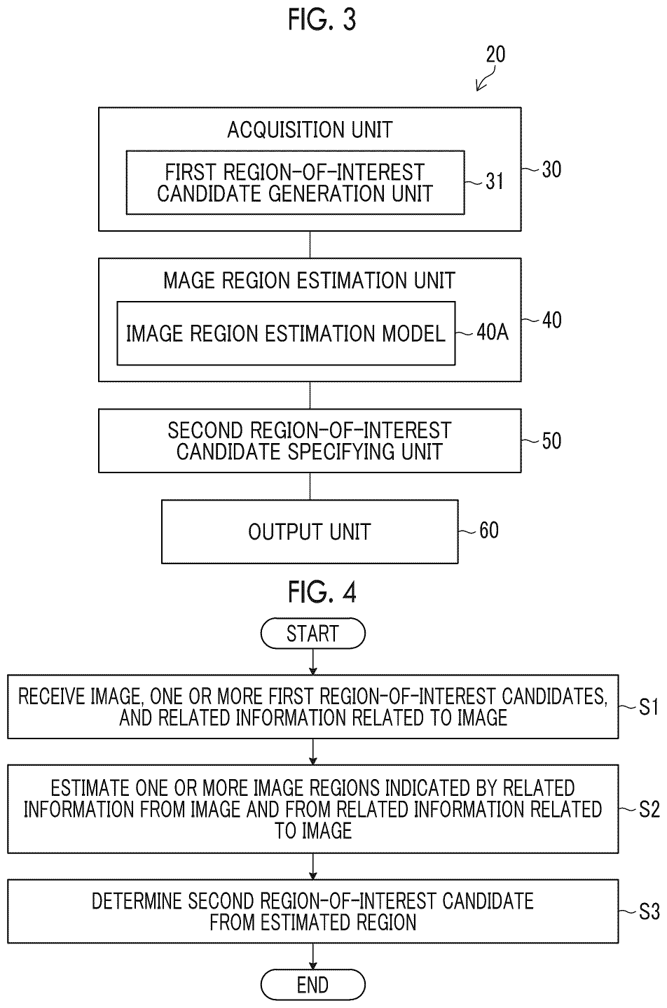

FIG. 3 is a block diagram illustrating a functional configuration of the medical information processing apparatus 20. Each function of the medical information processing apparatus 20 is implemented by executing the medical information processing program stored in the memory 20B via the processor 20A. As illustrated in FIG. 3, the medical information processing apparatus 20 comprises an acquisition unit 30, an image region estimation unit 40, a second region-of-interest candidate specifying unit 50, and an output unit 60.

The acquisition unit 30 acquires the medical image, the related information related to the medical image, and one or more first region-of-interest candidates that are first region-of-interest candidates included in the medical image and that are not associated with the related information. The first region-of-interest candidate includes at least one of a bounding box, a heatmap, or a mask.

The acquisition unit 30 acquires the medical image from the medical image database 14. The acquisition unit 30 acquires the reading report paired with the medical image as the related information related to the medical image from the reading report database 18. The related information is not limited to the entire reading report and may be a part decomposed (structured) by the size, the position, the property, or the like of the lesion.

The acquisition unit 30 comprises a first region-of-interest candidate generation unit 31. The first region-of-interest candidate generation unit 31 acquires the first region-of-interest candidate by generating the first region-of-interest candidate based on the medical image received by the acquisition unit 30. The first region-of-interest candidate generation unit 31 may perform processing of disposing a plurality of bounding boxes as the first region-of-interest candidates at a constant interval on the medical image in a rule-based manner like anchors of object detection. The acquisition unit 30 may dispose the first region-of-interest candidates using a known technique such as selective search.

The acquisition unit 30 may receive input of the medical image, the related information, and the first region-of-interest candidate. The acquisition unit 30 may receive input of the first region-of-interest candidate stored in a first region-of-interest candidate storage unit, not illustrated, provided in the memory 20B.

The image region estimation unit 40 estimates one or more image regions indicated by the related information from the medical image and the related information acquired by the acquisition unit 30. The image region estimated by the image region estimation unit 40 includes at least one of a bounding box, a heatmap, or a mask.

The image region estimation unit 40 comprises an image region estimation model 40A. A neural network (NN) that is trained to estimate an approximate position of a region of interest in a case where an image and a text are input is applied as the image region estimation model 40A. The image region estimation model 40A is stored in the memory 20B.

The second region-of-interest candidate specifying unit 50 determines a second region-of-interest candidate from among the first region-of-interest candidates acquired by the acquisition unit 30 based on the image region estimated by the image region estimation unit 40. The second region-of-interest candidate specifying unit 50 may determine the first region-of-interest candidate included in the image region estimated by the image region estimation unit 40 among one or more first region-of-interest candidates acquired by the acquisition unit 30 as the second region-of-interest candidate. The acquisition unit 30 may acquire a plurality of the first region-of-interest candidates, and the second region-of-interest candidate specifying unit 50 may determine the second region-of-interest candidate from among the plurality of first region-of-interest candidates.

The output unit 60 outputs the second region-of-interest candidate specified by the second region-of-interest candidate specifying unit 50 and records the second region-of-interest candidate in a database for learning, not illustrated, in association with the medical image. The output unit 60 may assign a bounding box, a heatmap, or a mask to a position of the second region-of-interest candidate in the medical image and output the second region-of-interest candidate. The medical image in which the bounding box, the heatmap, or the mask is assigned to the position of the second region-of-interest candidate can be used as the correct answer data in training the learning model that estimates the region of interest from the medical image.

Medical Information Processing Method: First Embodiment

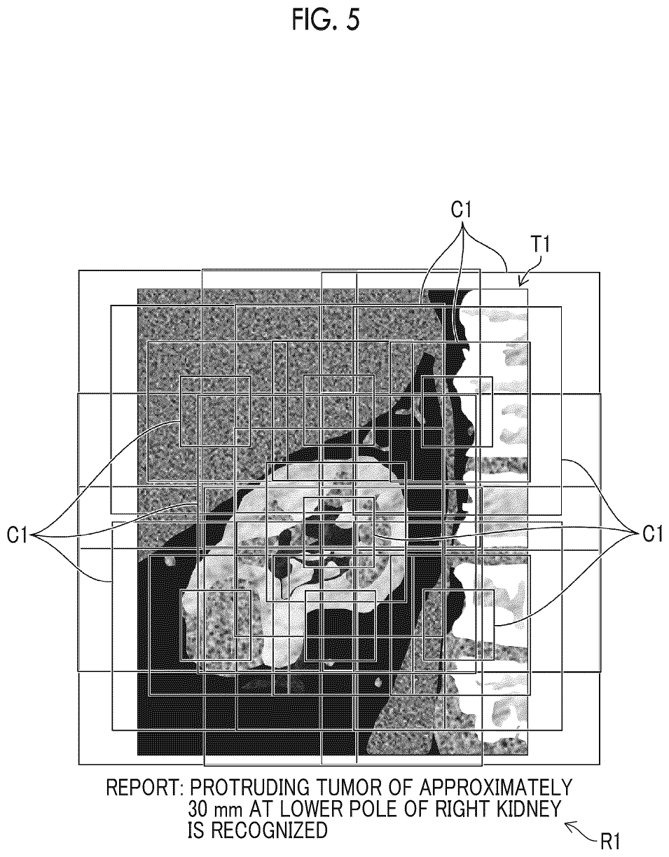

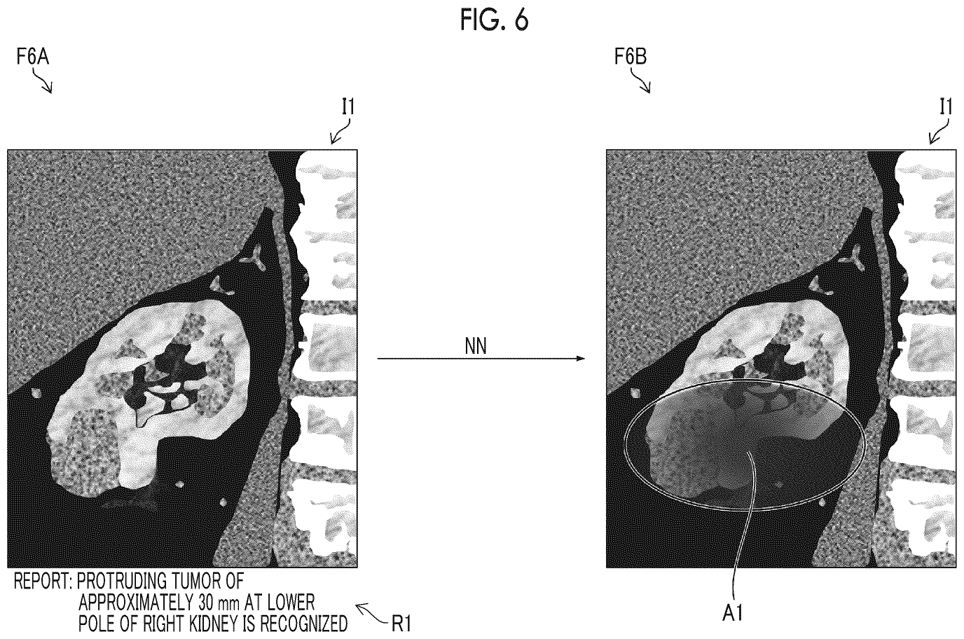

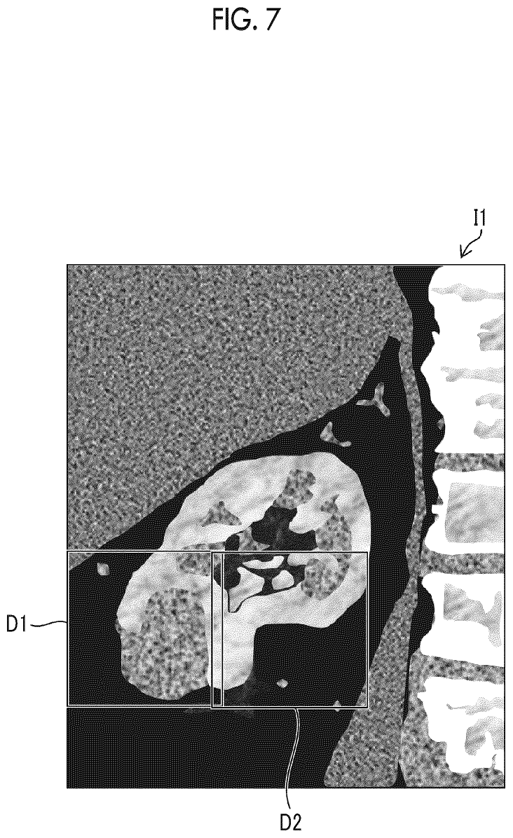

FIG. 4 is a flowchart illustrating the medical information processing method using the medical information processing apparatus 20. In addition, FIG. 5, FIG. 6, and FIG. 7 are diagrams for describing processing of each step of the medical information processing method. The medical information processing method is a method of determining the lesion candidate that is the region-of-interest candidate of the medical image from the medical image and from the related information related to the medical image. The medical information processing method is implemented by executing the medical information processing program stored in the memory 20B via the processor 20A. The medical information processing program may be provided by a computer readable non-transitory storage medium or may be provided through the Internet.

In step S1, the acquisition unit 30 receives the medical image, one or more first region-of-interest candidates of the medical image, and the related information related to the medical image through the network 22. The acquisition unit 30 may receive input of the medical image and the related information and generate the first region-of-interest candidate in the first region-of-interest candidate generation unit 31 based on the received medical image.

FIG. 5 is a diagram illustrating a medical image I1, a first region-of-interest candidate C1 disposed on the medical image I1, and related information R1 of the medical image I1 received by the acquisition unit 30. In this case, the first region-of-interest candidate C1 is a rectangular bounding box, and a plurality of the first region-of-interest candidates C1 are disposed on the medical image I1. The first region-of-interest candidate C1 may be a heatmap or a mask.

The related information R1 is a reading report including a text described as “protruding tumor of approximately 30 mm at lower pole of right kidney is recognized.” with respect to the region of interest. In this example, “lower pole of right kidney” represents a position of the region of interest, “approximately 30 mm” represents a size of the region of interest, and “protruding” represents a property of the region of interest. The related information may include information about a structured text.

In step S2, the image region estimation unit 40 estimates one or more image regions indicated by the related information from the medical image and the related information acquired in step S1 using the image region estimation model 40A. F6A in FIG. 6 shows the medical image I1 and the related information R1. In addition, F6B in FIG. 6 shows the medical image I1 and an estimated image region A1. The image region A1 is a mask with which at least one of an approximate position or an approximate size of the region of interest of the medical image I1 can be specified. The image region A1 may be a bounding box or a heatmap.

In step S3, the second region-of-interest candidate specifying unit 50 determines the second region-of-interest candidate from among the first region-of-interest candidates acquired in step S1 based on the image region estimated in step S2. FIG. 7 illustrates the medical image I1 and determined second region-of-interest candidates D1 and D2. The first region-of-interest candidate C1 included in the image region A1 among the plurality of first region-of-interest candidates C1 is selected as each of the second region-of-interest candidates D1 and D2.

According to the medical information processing method, the region-of-interest candidate of the medical image can be determined using the related information related to the medical image, and the related information and the region-of-interest candidate in the medical image can be associated with each other. In addition, performance of an object detection model can be improved using information about the region-of-interest candidate in the medical image determined using the medical information processing method. The medical image and the determined region-of-interest candidate may be stored in association with each other and be used as training data of the object detection model.

Related Information

The related information related to the image is information not including positional coordinate information with which positional coordinates of the region of interest in the image are specified. In a case where information with which the positional coordinates of the region of interest in the image may be specified is originally provided as the “related information” associated with the image, it is not required to estimate the region of interest from the image using the image region estimation unit 40.

In the present embodiment, it is assumed that the positional coordinate information of the region of interest is not associated with the image, and a text such as a report described with respect to the region of interest in the image is used instead of the positional coordinate information. That is, it is assumed that the image acquired in the present embodiment is not associated with the positional coordinate information of the region of interest. Alternatively, even in a case where the image is associated with the positional coordinate information of the region of interest, it is assumed not to use the information.

Generation of First Region-of-Interest Candidate

The first region-of-interest candidate may be randomly disposed on the image, or a plurality of rectangles of one or more types having a predetermined size and a predetermined width-to-height ratio may be arranged in a lattice form. The first region-of-interest candidate may be a bounding box group stored in advance in a memory or may be input through a user interface. In addition, the first region-of-interest candidate may be adaptively generated based on the input image. For example, means for generating the first region-of-interest candidate may be an object detection system using a framework for object detection represented by faster region-based convolutional neural networks (R-CNN) or by you only look once (YOLO).

### Modification Example

The acquisition unit 30 may include a first region-of-interest candidate estimation model and generate the first region-of-interest candidate from the medical image using the first region-of-interest candidate estimation model. The first region-of-interest candidate estimation model is a machine learning model that is trained to receive input of the medical image and estimate one or more first region-of-interest candidates from the medical image. A neural network may be applied as the first region-of-interest candidate estimation model. The first region-of-interest candidate estimation model is stored in the memory 20B.

The acquisition unit 30 may include the object detection model and generate one or more first region-of-interest candidates from the medical image using the object detection model. As will be described later, the object detection model is a model that is trained by machine learning using training data including the determined region-of-interest candidate. A neural network may be applied as the object detection model. The object detection model is stored in the memory 20B.

The image region estimation unit 40 may include an organ recognition unit. The organ recognition unit recognizes an organ included in the medical image acquired by the acquisition unit 30. A neural network may be applied as the organ recognition unit.

The image region estimation unit 40 may include a position size property estimation unit. The position size property estimation unit estimates at least one of a position, a size, or a property indicated by the text of the related information acquired by the acquisition unit 30. The image region estimation unit 40 may estimate the image region in a rule-based manner from a recognition result of the organ and from the position, the size, and the property indicated by the text of the related information.

The image region estimation unit 40 may include a probability calculation unit and estimate the image region using the probability calculation unit. The probability calculation unit calculates a probability for the image region indicated by the related information in pixel units of the medical image.

The second region-of-interest candidate specifying unit 50 may include a confidence degree calculation unit. The confidence degree calculation unit calculates a confidence degree of the first region-of-interest candidate acquired by the acquisition unit 30. The second region-of-interest candidate specifying unit 50 may update and correct a confidence degree of the first region-of-interest candidate calculated by the confidence degree calculation unit and delete the first region-of-interest candidate that does not correspond to the image region estimated by the image region estimation unit 40 among one or more first region-of-interest candidates.

The second region-of-interest candidate specifying unit 50 may include an evaluation value calculation unit. The evaluation value calculation unit calculates an evaluation value of one or more first region-of-interest candidates from the image region estimated by the image region estimation unit 40. The second region-of-interest candidate specifying unit 50 may determine the second region-of-interest candidate based on the evaluation value calculated by the evaluation value calculation unit.

Details of Image Region Estimation Unit

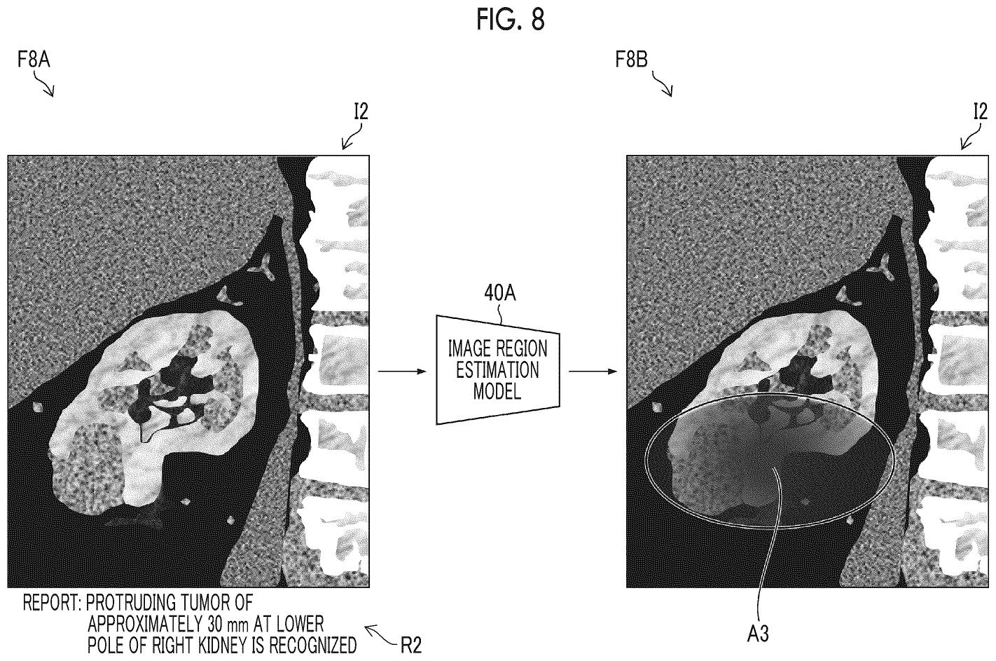

FIG. 8 is a diagram for describing an example of processing performed by the image region estimation unit 40. F8A in FIG. 8 shows a medical image I2 and related information R2 acquired by the acquisition unit 30. The related information R2 includes a text “protruding tumor of approximately 30 mm at lower pole of right kidney is recognized.”. In a case where the medical image I2 and the related information R2 are input, the image region estimation model 40A outputs an image region A3 estimated from the medical image I2.

F8B in FIG. 8 shows the medical image I2 and the image region A3 output from the image region estimation model 40A. The image region A3 is a mask with which at least one of an approximate position or an approximate size of the region of interest of the medical image I2 can be specified.

In such a manner, the image region estimation unit 40 can estimate the image region from the medical image using the image region estimation model 40A.

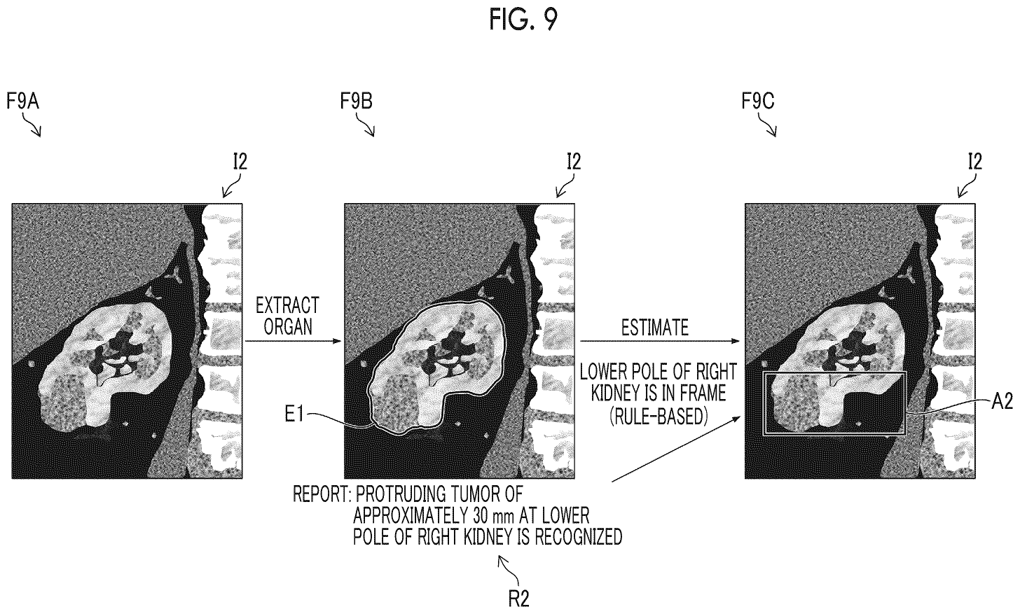

FIG. 9 is a diagram for describing another example of the processing performed by the image region estimation unit 40. Here, an example of using the organ recognition unit and the position size property estimation unit instead of the image region estimation model 40A will be described. F9A in FIG. 9 shows the medical image I2 acquired by the acquisition unit 30.

The organ recognition unit of the image region estimation unit 40 recognizes the organ included in the medical image I2. F9B in FIG. 9 shows the medical image I2, an organ E1 extracted from the medical image I2 by the organ recognition unit, and the related information R2 of the medical image I2 acquired by the acquisition unit 30. Here, the extracted organ E1 is shown with a line surrounding the organ E1.

Furthermore, the image region estimation unit 40 estimates the image region from the extracted organ E1 and from the related information R2. That is, the position size property estimation unit estimates the position “lower pole of right kidney”, the size “approximately 30 mm”, and the property “protruding” from the text of the related information R2. The image region estimation unit 40 estimates the image region with respect to the organ E1 in a rule-based manner based on the estimated position, size, and property. F9C in FIG. 9 shows the medical image I2 and an image region A2 estimated by the image region estimation unit 40. The image region A2 is a bounding box with which at least one of an approximate position or an approximate size of the region of interest of the medical image I2 can be specified.

In such a manner, the image region estimation unit 40 can recognize the organ from the medical image and estimate the image region using a rule-based model.

### Medical Information Processing Method: Second Embodiment

In a second embodiment, an example of improving accuracy of object detection using the configuration described in the first embodiment will be described.

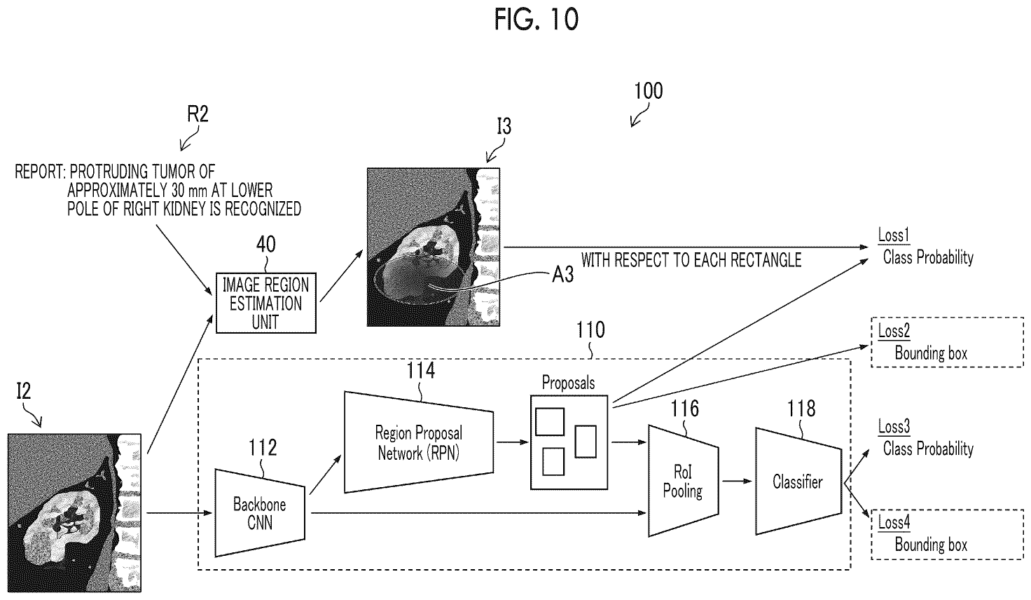

FIG. 10 is a block diagram schematically illustrating a functional configuration of an object detection system 100 according to the second embodiment. The object detection system 100 has a system configuration obtained by incorporating the configuration described in the first embodiment into a framework of a faster R-CNN 110.

That is, the object detection system 100 has a configuration obtained by adding the image region estimation unit 40 to a network structure of the faster R-CNN 110 comprising a backbone convolutional neural network (CNN) 112, a region proposal network (RPN) 114, a region of interest (ROI) pooling unit 116, and a classifier 118.

The backbone CNN 112 is a neural network including a plurality of convolutional layers and acts as a feature extractor that extracts a feature of the input image. An existing feature extractor may be applied as the backbone CNN 112.

The RPN 114 takes input of a feature map output from the backbone CNN 112 and outputs a region (hereinafter, referred to as a “region candidate”) that is a candidate of an object region. The “object region” in the object detection system 100 handling the medical image is, for example, the region of interest such as a lesion region. The region candidate output from the RPN 114 corresponds to the “first region-of-interest candidate” described in the first embodiment. The RPN 114 disposes a plurality of anchor boxes on the feature map and outputs a score of object-likeness for each anchor box. The RPN 114 may output a bounding box of one or more region-of-interest candidates having different width and height sizes and different width-to-height ratios (aspect ratios).

That is, the RPN 114 outputs one or more first region-of-interest candidates included in the medical image I2 based on the feature map output from the backbone CNN 112.

The ROI pooling unit 116 takes input of the output of the backbone CNN 112 and the output of the RPN 114, performs pooling processing with respect to a region of the feature map corresponding to the region candidate output by the RPN 114, and passes the feature map adjusted to have a predetermined size to the classifier 118.

The classifier 118 is configured using a CNN including a plurality of convolutional layers, takes input of the feature map corresponding to each region candidate output from the ROI pooling unit 116, and outputs a class probability of each class by performing class classification with respect to each region candidate. The class probability output by the classifier 118 may typically indicate the object-likeness of classification of two classes of “object (foreground)” that is a lesion and “background”. However, for example, in a case where a type of the lesion can be specified to a certain degree from a description content of the related information R2, the classifier 118 may be configured to perform classification of a tumor class such as “nodule” or “cyst” with respect to the region estimated by the RPN 114. Furthermore, the classifier 118 may output a bounding box surrounding the detected object (lesion).

In the case of a general faster R-CNN, learning is performed by calculating a loss (Loss1) related to the class probability of the object-likeness and a loss (Loss2) related to a deviation of the bounding box with respect to the output of the RPN 114 using a correct answer bounding box indicating a correct answer object region and by updating a parameter of the RPN 114 based on the losses. In addition, the same applies to the classifier 118. Learning is performed by calculating a loss (Loss3) related to the class probability of the class classification and a loss (Loss4) related to a deviation of the bounding box with respect to the output of the classifier 118 using a correct answer class and a correct answer bounding box and by updating parameters of the backbone CNN 112 and the classifier 118 based on the losses. By alternately performing a partial parameter update of the RPN 114 and a parameter update of the entire faster R-CNN including the backbone CNN 112 and the classifier 118, learning is performed while accuracy of each network model is increased.

However, in the second embodiment illustrated in FIG. 10, there is no correct answer bounding box with respect to the medical image I2, and data obtained by combining the medical image I2 with the related information R2 related to the medical image I2 is used in learning (training). That is, in the second embodiment, since data not having the correct answer bounding box is used, the losses (Loss2 and Loss4) for the correct answer bounding box cannot be calculated with respect to the output of the RPN 114 and to the output of the classifier 118.

At this point, the loss (Loss1) with respect to the class probability is calculated using the output from the image region estimation unit 40 instead of the correct answer bounding box in the second embodiment.

The image region estimation unit 40 takes input of the medical image I2 and the related information R2 related to the medical image I2, estimates an approximate location (image region) of the region of interest in the medical image I2 indicated by the related information R2, and outputs information about the estimated image region. For example, as illustrated in FIG. 10, in a case where the medical image I2 and the related information R2 are input, the image region estimation unit 40 outputs the image region A3. The image region A3 is a mask with which at least one of an approximate position or an approximate size of the region of interest of the medical image I2 can be specified.

The RPN 114 is trained to increase the class probability of the region candidate overlapping with the image region estimated by the image region estimation unit 40 among the region candidates estimated by the RPN 114. Accordingly, even in a case where the RPN 114 may not output the accurate bounding box corresponding to the region of interest, performance of outputting the region candidate in which the region of interest is present can be increased.

That is, the second region-of-interest candidate specifying unit 50 (not illustrated in FIG. 10; refer to FIG. 3) specifies the first region-of-interest candidate overlapping with the image region A3 estimated by the image region estimation unit 40 as the “second region-of-interest candidate” by evaluating a degree of overlapping (ratio of match) with the image region A3 for each first region-of-interest candidate from the image region A3 of the medical image I2 estimated by the image region estimation unit 40 and from the first region-of-interest candidates of the medical image I2 output by the RPN 114. During learning, the parameter of the RPN 114 is updated to increase the class probability of the second region-of-interest candidate specified by the second region-of-interest candidate specifying unit 50. The same applies to the class probability output by the classifier 118. The loss (Loss3) can be calculated using the output from the image region estimation unit 40.

In training all models of the actual object detection system 100, it is preferable to further use data to which the correct answer bounding box is assigned in training in addition to the data obtained by combining the image with the related information R2 related to the image. Accordingly, sensitivity of the RPN 114 can be further improved by calculating a loss for a position and a size of a bounding box with respect to a part of the training data having the correct answer bounding box and by updating the parameter of the network to alleviate a deviation of the bounding box based on the loss.

While an example of using the framework of the faster R-CNN 110 has been described in FIG. 10, the disclosed technology is not limited to a system of a two-stage detector as in FIG. 10. The disclosed technology can also be applied to an object detection system of a single stage detector such as YOLO and can also be embodied using a confidence score output by the single stage detector instead of the class probability described in FIG. 10.

Use of Image Region Estimation Unit 40 during Inference

By using the trained faster R-CNN 110 that is trained using the learning method described in FIG. 10, the region of interest in the image can be detected from only the image even in a case where there is no report related to the image during inference.

On the other hand, in a case where the report related to the image is present, an aspect such as correcting the class probability that is an inference result of the faster R-CNN 110 based on the output from the image region estimation unit 40 using the image region estimation unit 40 during inference is also possible.

Other

The medical information processing apparatus, the medical information processing method, and the medical information processing program according to the present embodiment can also be applied to an information processing apparatus, an information processing method, and a program using a natural image other than the medical image. For example, the disclosed technology can be applied to a technology for acquiring an image that is an image of social infrastructure equipment such as transportation, electricity, gas, and water supply and that has the related information and for specifying the region of interest in the image. Accordingly, the correct answer data indicating the region of interest can be easily created, and the learning model that estimates the region of interest from the image of the infrastructure equipment can be trained using the created correct answer data.

The technical scope of the present invention is not limited to the scope described in the embodiments. The configurations and the like in each embodiment can be appropriately combined between the embodiments without departing from the gist of the present invention.

### EXPLANATION OF REFERENCES

10: medical information processing system
12: medical image examination apparatus
14: medical image database
16: user terminal apparatus
16A: input device
16B: display
18: reading report database
20: medical information processing apparatus
20A: processor
20B: memory
20C: communication interface
22: network
30: acquisition unit
31: first region-of-interest candidate generation unit
40: image region estimation unit
40A: image region estimation model
50: second region-of-interest candidate specifying unit
60: output unit
100: object detection system
110: faster R-CNN
112: backbone CNN
114: RPN
116: ROI pooling unit
118: classifier
A1: image region
A2: image region
A3: image region
C1: first region-of-interest candidate
D1: second region-of-interest candidate
D2: second region-of-interest candidate
E1: organ
I1: medical image
I2: medical image
R1: related information
R2: related information
S1 to S3: step of medical information processing method

What is claimed is:

1. An information processing apparatus comprising:
one or more processors; and
one or more storage devices in which an instruction executed by the one or more processors is stored,
wherein the one or more processors are configured to:
acquire an image, related information related to the image, and one or more first region-of-interest candidates included in the image;
estimate one or more image regions indicated by the related information from the image and from the related information; and
determine a second region-of-interest candidate from among the first region-of-interest candidates based on the estimated image region.

2. The information processing apparatus according to claim 1,
wherein the related information includes a text related to a content of the image.

3. The information processing apparatus according to claim 1,
wherein the related information includes a text described with respect to a region of interest included in the image.

4. The information processing apparatus according to claim 1,
wherein the related information includes information about a structured text including at least one of a size, a position, or a property of a region of interest included in the image.

5. The information processing apparatus according to claim 2,
wherein the one or more processors are configured to estimate at least one of a position, a size, or a property indicated by the text.

6. The information processing apparatus according to claim 2,
wherein the image is a medical image, and
the one or more processors are configured to:
recognize an organ included in the image; and
estimate the image region from the text and from a recognition result of the organ.

7. The information processing apparatus according to claim 1,
wherein the one or more first region-of-interest candidates include at least one of a bounding box, a heatmap, or a mask.

8. The information processing apparatus according to claim 1,
wherein the one or more processors are configured to receive input of the image, the related information, and the one or more first region-of-interest candidates.

9. The information processing apparatus according to claim 1,
wherein the one or more processors are configured to:
receive input of the image and the related information; and
acquire the one or more first region-of-interest candidates by generating the one or more first region-of-interest candidates based on the received image.

10. The information processing apparatus according to claim 9,
wherein the one or more processors are configured to perform processing of disposing a plurality of bounding boxes as the first region-of-interest candidates at a constant interval on the image in a rule-based manner.

11. The information processing apparatus according to claim 9,
wherein the one or more processors are configured to generate the one or more first region-of-interest candidates from the image using a machine learning model that is trained to receive input of the image and estimate the one or more first region-of-interest candidates from the image.

12. The information processing apparatus according to claim 9,
wherein the one or more processors are configured to generate the one or more first region-of-interest candidates from the image using an object detection model.

13. The information processing apparatus according to claim 12,
wherein the object detection model is a model that is trained by machine learning using training data including the determined second region-of-interest candidate.

14. The information processing apparatus according to claim 1,
wherein the one or more processors are configured to determine the first region-of-interest candidate included in the estimated image region among the one or more first region-of-interest candidates as the second region-of-interest candidate.

15. The information processing apparatus according to claim 1,
wherein the one or more processors are configured to:
acquire a plurality of the first region-of-interest candidates; and
determine the second region-of-interest candidate from among the plurality of first region-of-interest candidates.

16. The information processing apparatus according to claim 1,
wherein the one or more processors are configured to calculate a probability for the image region indicated by the related information in pixel units of the image.

17. The information processing apparatus according to claim 1,
wherein the image region estimated by the one or more processors includes at least one of a bounding box, a heatmap, or a mask.

18. The information processing apparatus according to claim 1,
wherein the one or more processors are configured to:
calculate a confidence degree of the first region-of-interest candidate; and
delete the first region-of-interest candidate not corresponding to the estimated image region among the one or more first region-of-interest candidates.

19. The information processing apparatus according to claim 1,
wherein the one or more processors are configured to:
calculate an evaluation value of the one or more first region-of-interest candidates from the estimated image region; and
determine the second region-of-interest candidate based on the evaluation value.

20. An information processing method executed by one or more processors, the information processing method comprising:
via the one or more processors,
acquiring an image, related information related to the image, and one or more first region-of-interest candidates included in the image;
estimating one or more image regions indicated by the related information from the image and from the related information; and
determining a second region-of-interest candidate from among the first region-of-interest candidates based on the estimated image region.

21. A non-transitory, computer-readable tangible recording medium which records thereon a program for causing, when read by a computer, the computer to implement:
a function of acquiring an image, related information related to the image, and one or more first region-of-interest candidates included in the image;
a function of estimating one or more image regions indicated by the related information from the image and from the related information; and
a function of determining a second region-of-interest candidate from among the first region-of-interest candidates based on the estimated image region.
